(19) United States
(12) Patent Application Publication
(10) Pub. No.: US 2017/0173806 A1
(43) Pub. Date: Jun. 22, 2017

(54) BIAXIAL RAZOR

(71) Applicant: Tsung-Shih Lee, New Taipei (TW)

(72) Inventor: Tsung-Shih Lee, New Taipei (TW)

(21) Appl. No.: 14/970,560

(22) Filed: Dec. 16, 2015

(51) Int. Cl. B26B 21/52

(52) U.S. Cl. CPC B26B 21/521

(57) ABSTRACT

A biaxial razor is disclosed. The biaxial razor includes a shaving head, a handle, and a pivot assembly arranged between the shaving head and the handle. The pivot assembly is composed of a first axial driving group and a second axial driving group. The first and second axial driving groups enable the shaving head to make both a rotating displacement in a front-rear direction and a swing displacement in a left-right direction, so as to perfectly fit with facial skins of users whose face contours are different, without taking lots of arm motions in operations when shaving, thereby to enhance the convenience in operations and improve the efficiency in shaving.

### BACKGROUND OF THE INVENTION

1. Field of the Invention

The present invention relates to a biaxial razor. More particularly, the present invention relates to a biaxial razor, enabling its shaving head to make both a rotating displacement in a front-rear direction and a swing displacement in a left-right direction to perfectly fit with facial skins of users.

2. Related Art

There are many types of razors on the market manufactured for different functions. Conventionally, for a razor in double-edge blade type, it is usually composed of a shaving head, a handle, and a pivot arranged between the shaving head and the handle, characterized in that the pivot allows the shaving head to make a rotating displacement in a front-rear direction, so as to provide the shaving head to move along the surface of the facial skin when shaving.

However, although this razor type offers better mobility on facial skin when shaving, there is still a poor fit between the shaving head and the facial skin, so that users need to take lots of arm motions for thoroughly shaving off beards. It is inconvenient in operations.

### SUMMARY OF THE INVENTION

An object of the present invention is to provide a biaxial razor, enabling its shaving head to make both a rotating displacement in a front-rear direction and a swing displacement in a left-right direction, thus to perfectly fit with facial skins of users whose face contours are different, without taking lots of arm motions in operations when shaving, so as to enhance the convenience in operations and improve the efficiency in shaving.

To attain this, the biaxial razor includes: a shaving head, a handle, and a pivot assembly arranged between the shaving head and the handle, wherein: the shaving head has a layer structure composed of a substrate, a bilateral blade and a cover board from bottom to top, the substrate is protruded downward to form a first pressing block, and left and right ends of the first pressing block further extend downward to form a pair of rings; and the pivot assembly is composed of a first axial driving group and a second axial driving group, wherein the first axial driving group includes a first adjustable shelf, a first stationary seat and a first spring; the first adjustable shelf has a first pressed plate upwardly abutted on the first pressing block to make sure that when shaving, the first pressing block that is tilted pushes the first pressed plate downward; front and rear ends of the first pressed plate extend downward to form a pair of grooves; the first stationary seat is a hexahedron having a left surface, a right surface, a front surface, a rear surface, a top surface and a bottom surface, and disposed on the left and right surfaces of the first stationary seat is a pair of positioning columns that coincides with the pair of rings in size to provide the assembly and positioning of the substrate of the shaving head and the first stationary seat; disposed on the front and rear surfaces of the first stationary seat is a pair of sliding columns that is longitudinally movable within the pair of grooves; the first spring is secured between the first adjustable shelf and the first stationary seat; the second axial driving group includes a second adjustable shelf, a second stationary seat and a second spring; the left and right surfaces of the first stationary seat extend downward to form a second pressing block corresponding to the second pressed plate; the second stationary seat has a base having a top surface, a bottom surface, a front surface, a rear surface, the front and rear surfaces of the base extend upward to form a pair of buckle holes that coincides with the pair of sliding columns in size to provide the assembly and positioning of the first and second stationary seats; the front and rear surfaces of the base are provided with a fixing element assembly for the combination with the handle; the top surface of the base of the second stationary seat is recessed to form a second sink that allows the second adjustable shelf to longitudinally slide therein; the second spring is secured between the second pressed plate and the second stationary seat; wherein the pair of rings and the pair of buckle holes are both circular in shape, thus to allow the pair of positioning columns and the pair of sliding columns to rotate therein, respectively, i.e., when the first axial driving group is driven, the shaving head makes a rotating displacement in a front-rear direction with the pair of positioning columns received in the pair of rings as a pivot, and when the second axial driving group is driven, the shaving head makes a swing displacement in a left-right direction with the pair of sliding columns received in the pair of buckle holes as a pivot.

In according with the present invention, the substrate comprises a main board and a pair of sliding panels, the main board is substantively rectangular and has a long axis and a short axis that are perpendicular to each other, a pair of through holes is formed at left and right ends of the long axis of the main board and longitudinally penetrates the substrate, a pair of openings is formed on a surface of the bilateral blade corresponding to the pair of through holes, and the pair of sliding panels comprises a left sliding panel and a right sliding panel, the left sliding panel and the right sliding panel are actively assembled to left and right ends of a bottom surface of the main board, respectively, each of the left sliding panel and the right sliding panel is mounted with a first hook that extends toward the main board, the cover board is mounted with a second hook at left and right ends thereof, the second hook passes through each of the pair of openings and each of the pair of through holes to fasten with the first hook, thereby combining the substrate, the bilateral blade and the cover board together stably.

In according with the present invention, a first magnet is embedded in each of the left sliding panel and the right sliding panel while a second magnet magnetically attracted by the first magnet is embedded in the main board, wherein the first magnet is kept close to the first hook and the second magnet is kept close to the second hook, so that when the pair of sliding panels is moved laterally, the first hook of each of the left and right sliding panel is separated from the second hook of the cover board to dissemble the shaving head for the replacement of the bilateral blade, and when the cover board is assembled with the substrate, the first and second hooks rapidly fasten each other by magnetic attraction between the first and second magnets so as to realize quick combination.

In according with the present invention, the second pressed plate has a first slant face at top, and the second pressing block has a second slant face at bottom that fits with the first slant face of the second pressed plate to strengthen the combination of the first stationary seat and the second adjustable shelf at rest, so that when shaving, the second pressing block that is tilted pushes the second pressed plate downward, and when the second pressed plate stops being pushed, the second pressing block returns to its rest position along the first and second slant faces rapidly.

In according with the present invention, edges of the second pressed plate extend downward to form a pair of third hooks, and a pair of slide chutes is longitudinally arranged on an inside wall of the second sink and allows the pair of third hooks to slide longitudinally therein, a pair of limiting members is mounted around upper ends of the pair of slide chutes to prevent the pair of third hooks from slipping out of the pair of slide chutes, so that the second adjustable shelf makes a longitudinal movement by sliding along the pair of slide chutes with the third hook, and the longitudinal movement range of the second adjustable shelf is limited by the pair of limiting members so as to prevent the second adjustable shelf to impact against the first stationary seat when the second adjustable shelf returns to its rest position, thereby to make sure the shaving head moves smoothly on user's face during shaving.

In according with the present invention, the fixing element assembly comprises a pair of fixing bones protruded from the front and rear surfaces of the base and a pair of fixing holes recessed on the base, and the handle is relatively mounted with a pair of fixing frames corresponding to the pair of fixing bones of the second stationary seat and a pair of fixing rods corresponding to the pair of fixing holes.

### BRIEF DESCRIPTION OF THE DRAWINGS

FIG. 1 is a perspective view of the biaxial razor of the present invention;

FIG. 2 is an exploded view of the pivot assembly and the handle of the biaxial razor of the present invention;

FIG. 3 is an exploded view of the shaving head and the pivot assembly of the biaxial razor of the present invention;

FIG. 4 is a cross-sectional view taken along lines 4-4 of FIG. 1;

FIG. 5A is a cross-sectional view illustrating the movement of the shaving head of the biaxial razor of FIG. 4 toward the first axial direction;

FIG. 5B is a perspective view of FIG. 5A;

FIG. 6A is a cross-sectional view taken along lines 6A-6A of FIG. 1;

FIG. 6B is a cross-sectional view illustrating the movement of the shaving head of the biaxial razor of FIG. 6A toward the second axial direction;

FIGS. 7A to 7C are perspective views of the shaving head of the biaxial razor of the present invention;

FIG. 7D is a perspective view of the main board of the substrate of the shaving head of the biaxial razor of the present invention;

FIGS. 7E to 7F are cross-sectional views illustrating the movement of the first and second hooks of the shaving head of the biaxial razor;

FIG. 8 is a perspective view illustrating the movement of the shaving head toward the front left direction.

### DESCRIPTION OF THE PREFERRED EMBODIMENTS

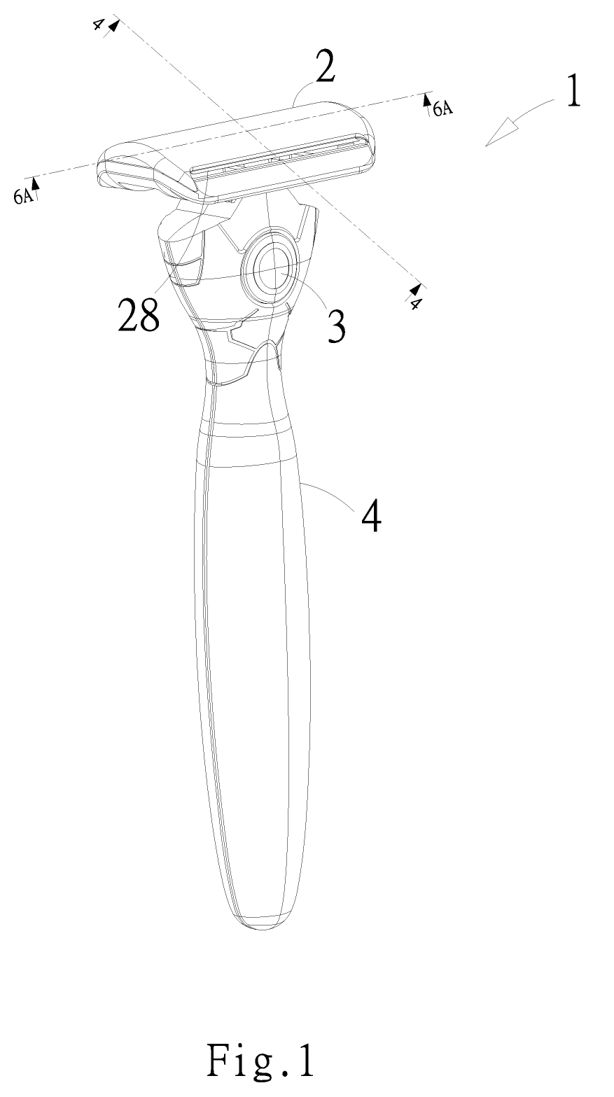

Please refer to FIGS. 1 to 4, a biaxial razor 1 of the present invention includes a shaving head 2, a handle 4, and a pivot assembly 3 arranged between the shaving head 2 and the handle 4.

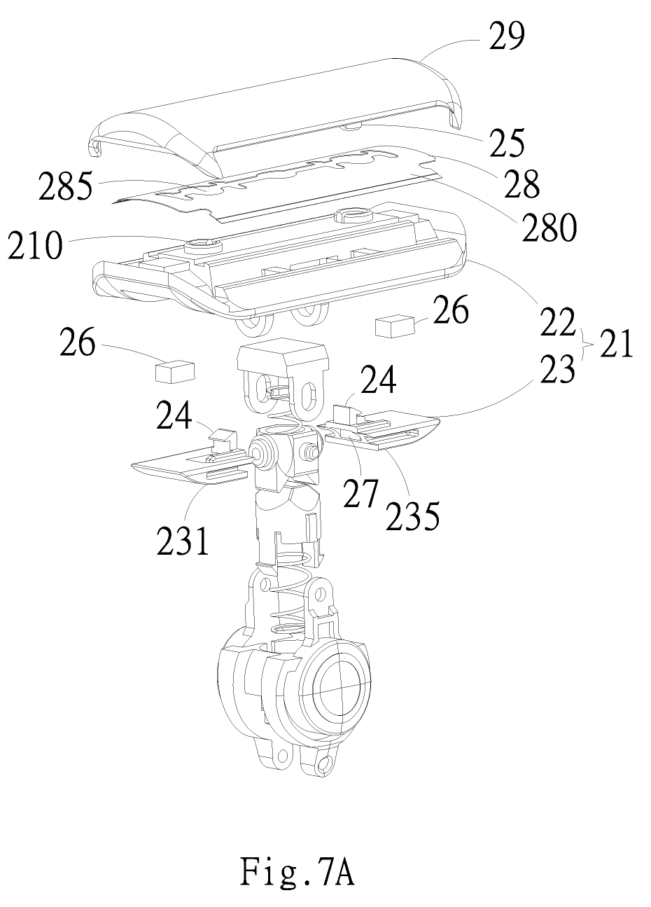

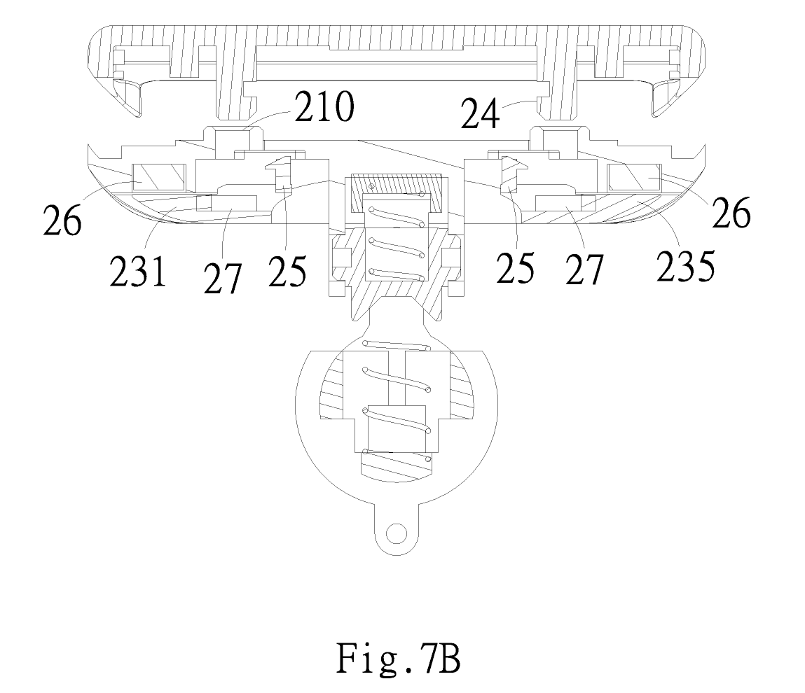

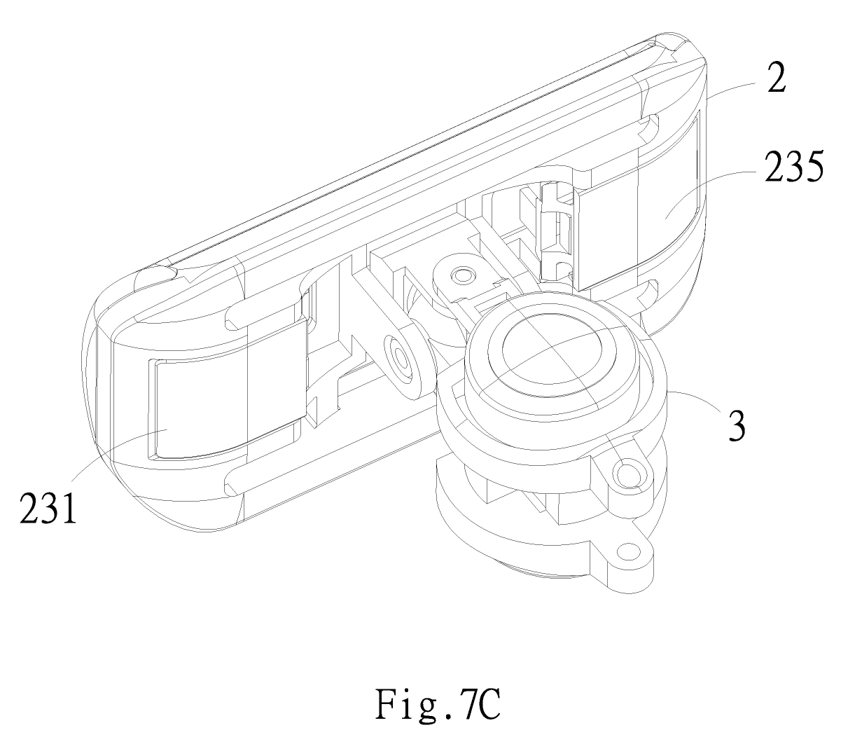

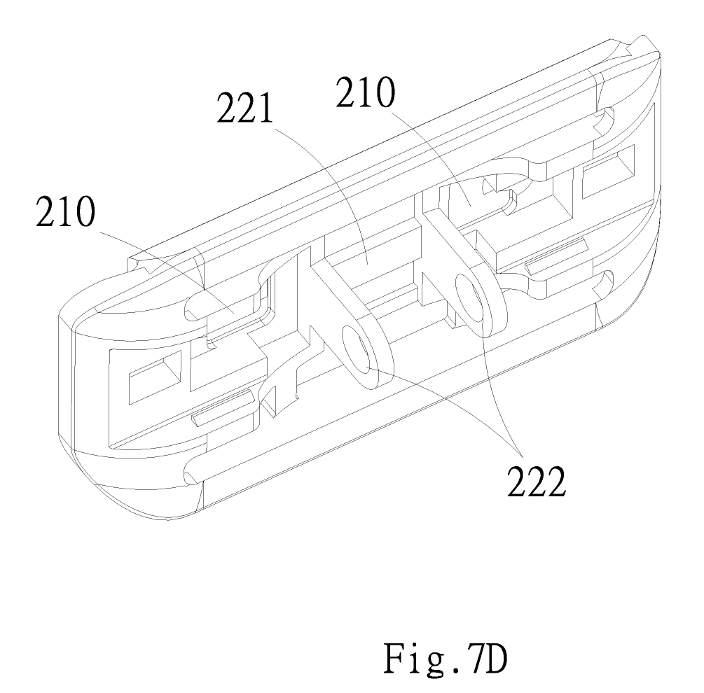

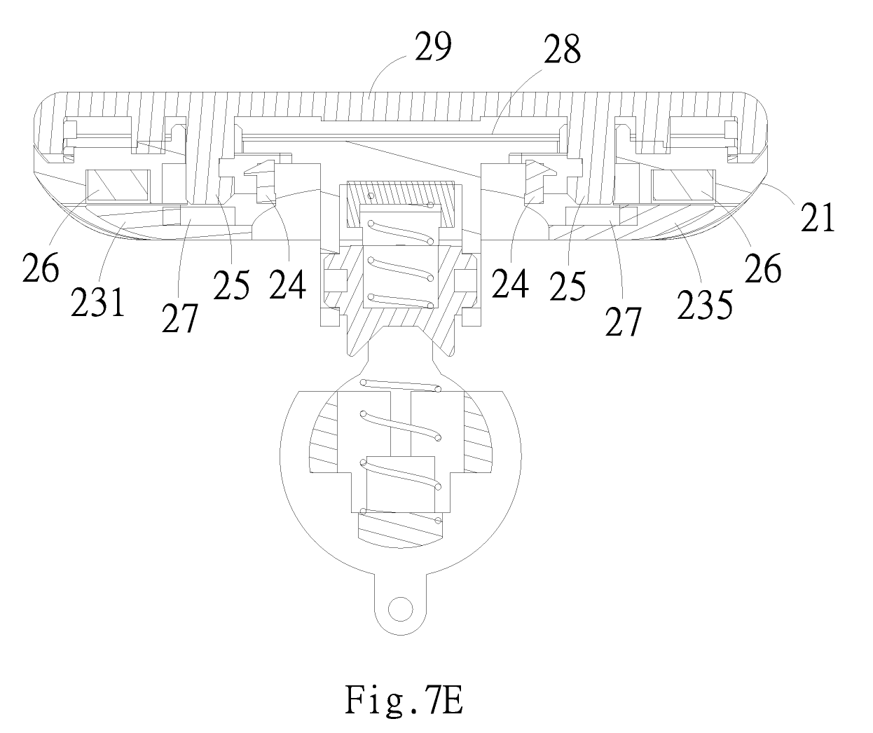

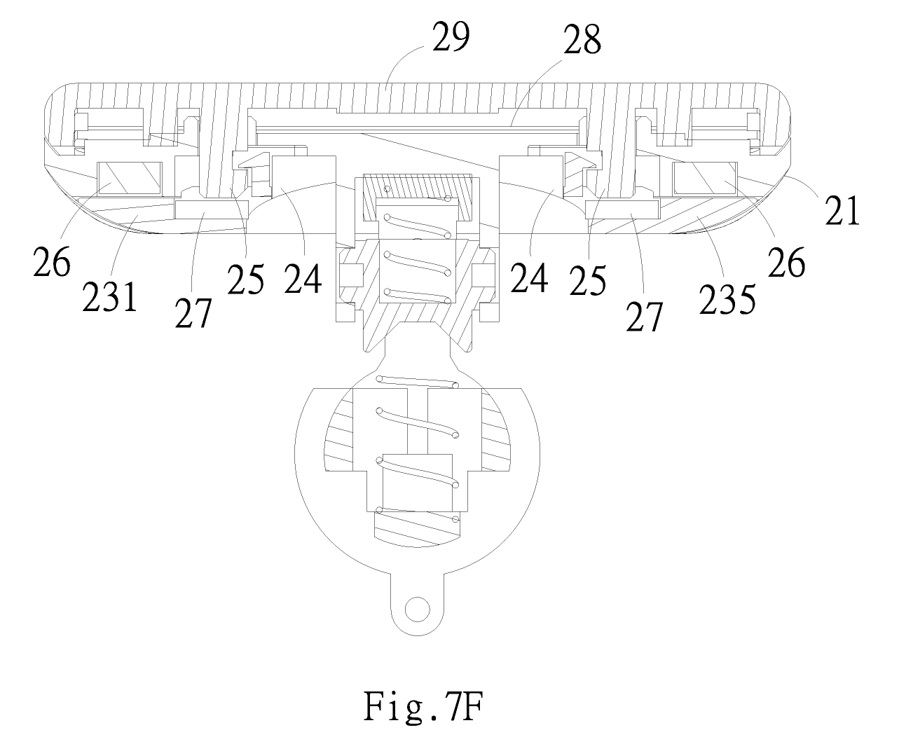

The shaving head 2 has a layer structure composed of a substrate 21, a bilateral blade 28 and a cover board 29 from bottom to top. The substrate 21 comprises a main board 22 and a pair of sliding panels 23 (refer to FIGS. 7A to 7D). The main board 22 is substantively rectangular and has a long axis and a short axis that are perpendicular to each other. A pair of through holes 210 is formed at left and right ends of the long axis of the main board 22 and longitudinally penetrates the substrate 21. A pair of openings 285 is formed on a surface 280 of the bilateral blade 28 corresponding to the pair of through holes 210. The pair of sliding panels 23 comprises a left sliding panel 231 and a right sliding panel 235. The left sliding panel 231 and the right sliding panel 235 are actively assembled to left and right ends of a bottom surface of the main board 22, respectively. Each of the left sliding panel 231 and the right sliding panel 235 is mounted with a first hook 24 that extends toward the main board 22. The cover board 29 is mounted with a second hook 25 at left and right ends thereof. The second hook 25 passes through each of the pair of openings 285 and each of the pair of through holes 210 to fasten with the first hook 24, thereby combining the substrate 21, the bilateral blade 28 and the cover board 29 together stably. In addition, a first magnet 26 is embedded in each of the left sliding panel 231 and the right sliding panel 235 while a second magnet 27 magnetically attracted by the first magnet 26 is embedded in the main board 22, wherein the first magnet 26 is kept close to the first hook 24 and the second magnet 27 is kept close to the second hook 25. Therefore, when the pair of sliding panels 23 is moved laterally, the first hook 24 of each of the left and right sliding panels 231,235 is separated from the second hook 25 of the cover board 29 to dissemble the shaving head 2, allowing for the replacement of the bilateral blade 28 (refer to FIG. 7E), and when the cover board 29 is assembled with the substrate 21, the first and second hooks 24,25 rapidly fasten each other by magnetic attraction between the first and second magnets 26,27 so as to realize quick combination(refer to FIG. 7F). Furthermore, a middle part of the main board 22 of the substrate 21 is protruded downward to form a first pressing block 221. Left and right ends of the first pressing block 221 further extend downward to form a pair of rings 222.

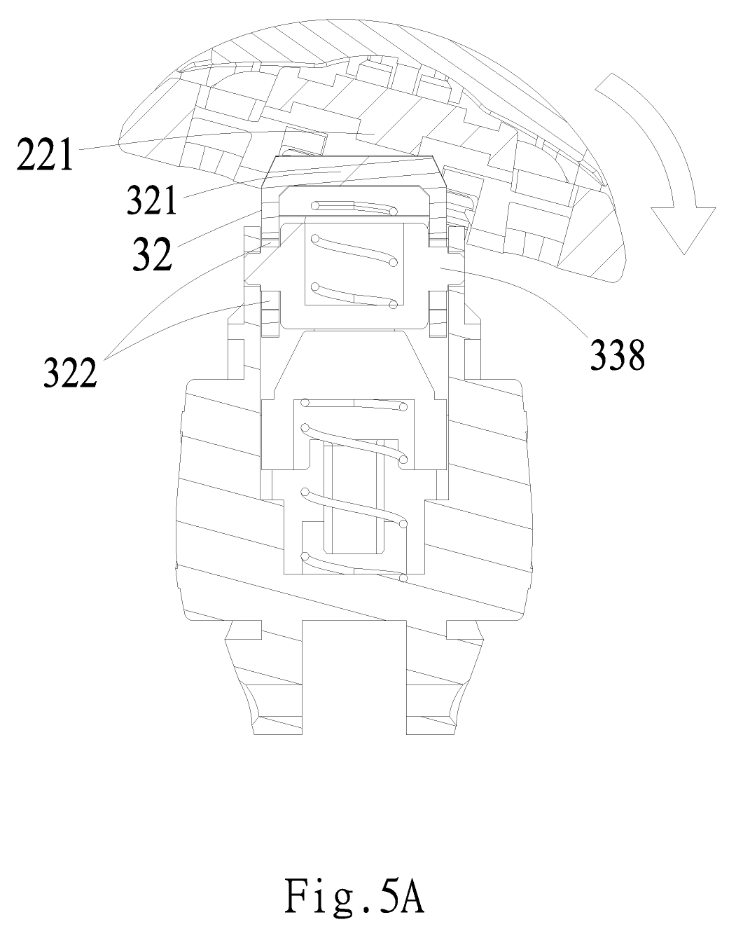

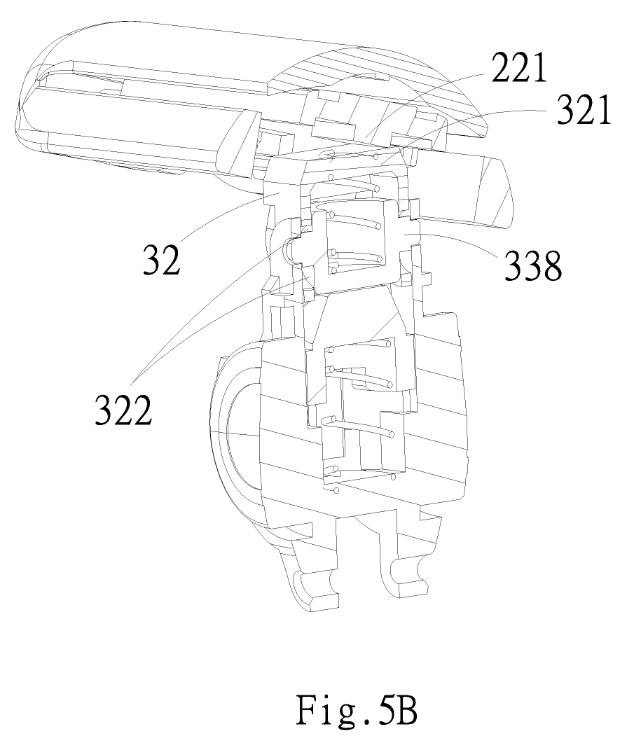

The pivot assembly 3 is composed of a first axial driving group 31 and a second axial driving group 35. The first axial driving group 31 includes a first adjustable shelf 32, a first stationary seat 33 and a first spring 34. The first adjustable shelf 32 has a first pressed plate 321 upward abutted on the first pressing block 221 to make sure that when shaving, the first pressing block 221 that is tilted pushes the first pressed plate 321 downward. Preferably, the first pressed plate 321 is designed to be flat so that when the first pressed plate 321 is pushed downward, a tilted side of the first pressing block 221 is capable of sliding on the first pressed plate 321 unimpededly (refer to FIG. 5A, 5B). Front and rear ends of the first pressed plate 321 extend downward to form a pair of grooves 322. The first stationary seat 33 is a hexahedron having a left surface 331, a right surface 332, a front surface 333, a rear surface 334, a top surface 335 and a bottom surface 336. Disposed on the left and right surfaces 331,332 of the first stationary seat 33 is a pair of positioning columns 337 that coincides with the pair of rings 222 in size to provide the assembly and positioning of the substrate 21 of the shaving head 2 and the first stationary seat 33. Disposed on the front and rear surfaces 333,334 of the first stationary seat 33 is a pair of sliding columns 338 that is longitudinally movable within the pair of grooves 322. To help with the movement of the pair of sliding columns 338 within the pair of grooves 322, longitudinal widths of the pair of grooves 322 may be made larger than longitudinal widths of the pair of sliding columns 338. The first spring 34 is a compression spring having an upper end 341 and a lower end 342. The upper end 341 of the first spring 34 is secured to the first pressed plate 321 of the first adjustable shelf 32, and the lower end 342 of the first spring 34 is secured to the top surface 335 of the first stationary seat 33. Alternatively, the top surface 335 of the first stationary seat 33 may be further recessed to form a first sink 339 to make the lower end 342 of the first spring 34 secured to bottom of the first sink 339, so as to improve assembly stability of the first spring 34.

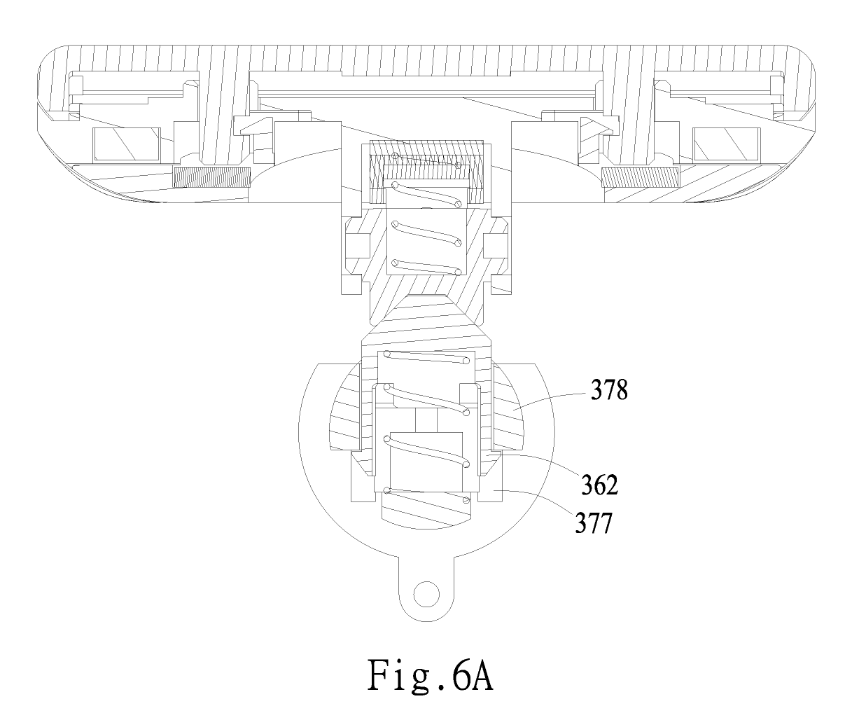

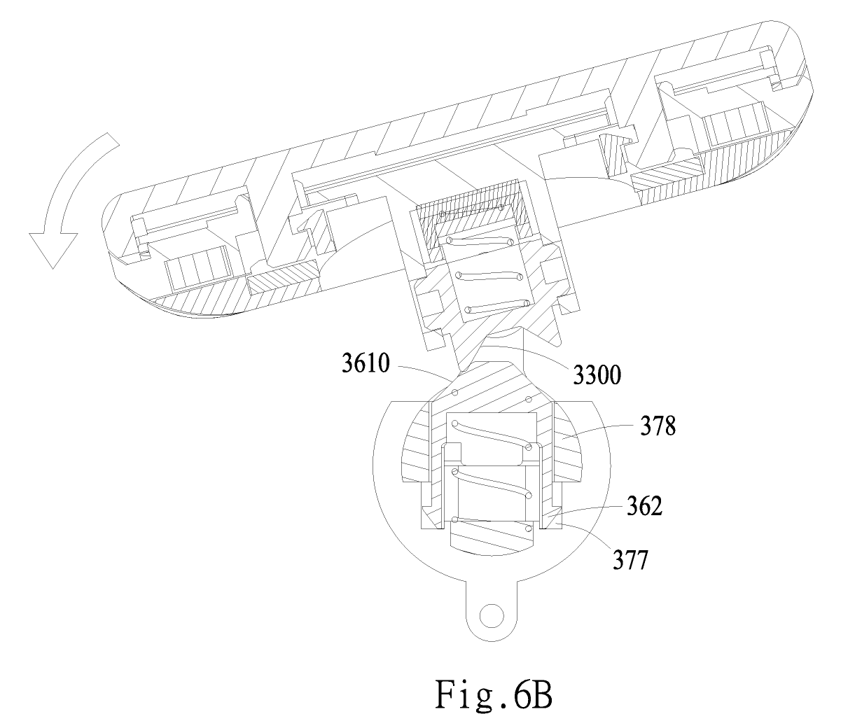

The second axial driving group 35 includes a second adjustable shelf 36, a second stationary seat 37 and a second spring 38. The second adjustable shelf 36 has a second pressed plate 361. The left and right surfaces 331,332 of the first stationary seat 33 of the first axial driving group 31 extend downward to form a second pressing block 330 corresponding to the second pressed plate 361, wherein the second pressed plate 361 has a first slant face 3610 at top, and the second pressing block 330 has a second slant face 3300 at bottom that fits with the first slant face 3610 of the second pressed plate 361 to strengthen the combination of the first stationary seat 33 and the second adjustable shelf 36 at rest, so that when shaving, the second pressing block 330 that is tilted pushes the second pressed plate 361 downward(refer to FIG. 6A), and when the second pressed plate 361 stops being pushed, the second pressing block 330 returns to its rest position along the first and second slant faces 3610,3300 rapidly(refer to FIG. 6B). In addition, edges of the second pressed plate 361 extend downward to form a pair of third hooks 362. The second stationary seat 37 has a base 370 having a top surface 371, a bottom surface 372, a front surface 373, a rear surface 374. The front and rear surfaces 373,374 of the base 370 extend upward to form a pair of buckle holes 3710 that coincides with the pair of sliding columns 338 in size to provide the assembly and positioning of the first and second stationary seats 33,37. The front and rear surfaces 373,374 of the base 370 are provided with a fixing element assembly 3730 for the combination with the handle 4. In practice, the fixing element assembly 3730 comprises a pair of fixing bones 3731 protruded from the front and rear surfaces 373,374 of the base 370 and a pair of fixing holes 3732 recessed on the base 370. The handle 4 is relatively mounted with a pair of fixing frames 41 corresponding to the pair of fixing bones 3731 of the second stationary seat 37 and a pair of fixing rods 42 corresponding to the pair of fixing holes 3732. The top surface 371 of the base 370 of the second stationary seat 37 is recessed to form a second sink 379. A pair of slide chutes 377 is longitudinally arranged on an inside wall of the second sink 379 and allows the pair of third hooks 362 to slide up and down therein. A pair of limiting members 378 is mounted around upper ends of the pair of slide chutes 377 to prevent the pair of third hooks 362 from slipping out of the pair of slide chutes 377. Hence, the second adjustable shelf 36 makes a longitudinal movement by sliding along the pair of slide chutes 377 with the third hook 362, and the longitudinal movement range of the second adjustable shelf 36 is limited by the pair of limiting members 378 so as to prevent the second adjustable shelf 36 to impact against the first stationary seat 33 when the second adjustable shelf 36 returns to its rest position, thereby to make sure the shaving head 2 moves smoothly on user's face during shaving. The second spring 38 is a compression spring having an upper end 381 and a lower end 382. The upper end 381 of the second spring 38 is secured to the second pressed plate 361 of the second adjustable shelf 36, and the lower end 382 of the second spring 38 is secured to bottom of the second sink 379 of the second stationary seat 37, so as to improve assembly stability of the second spring 38.

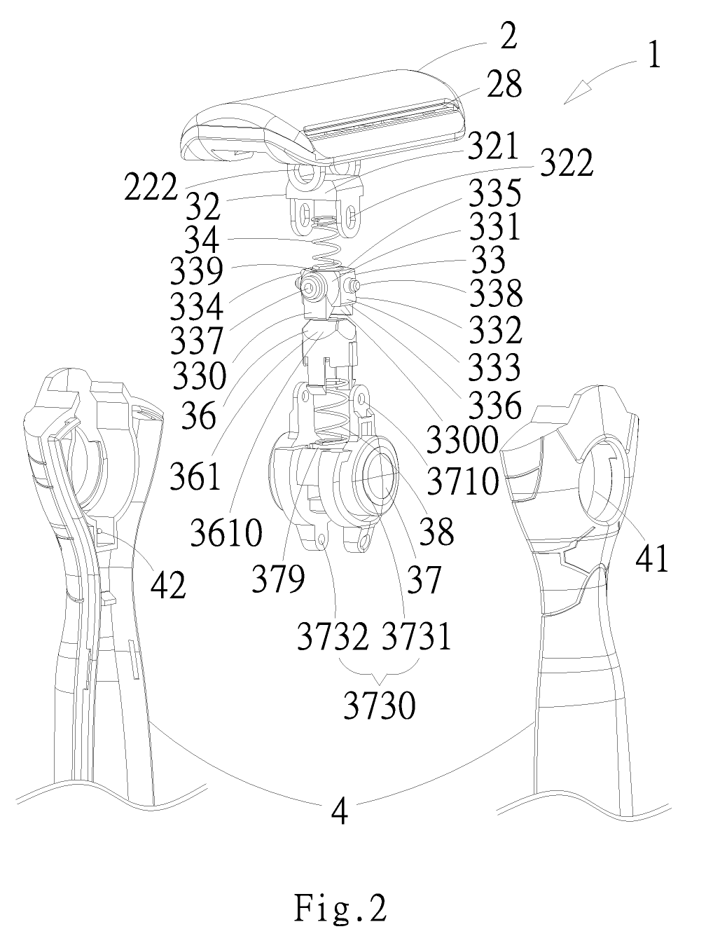

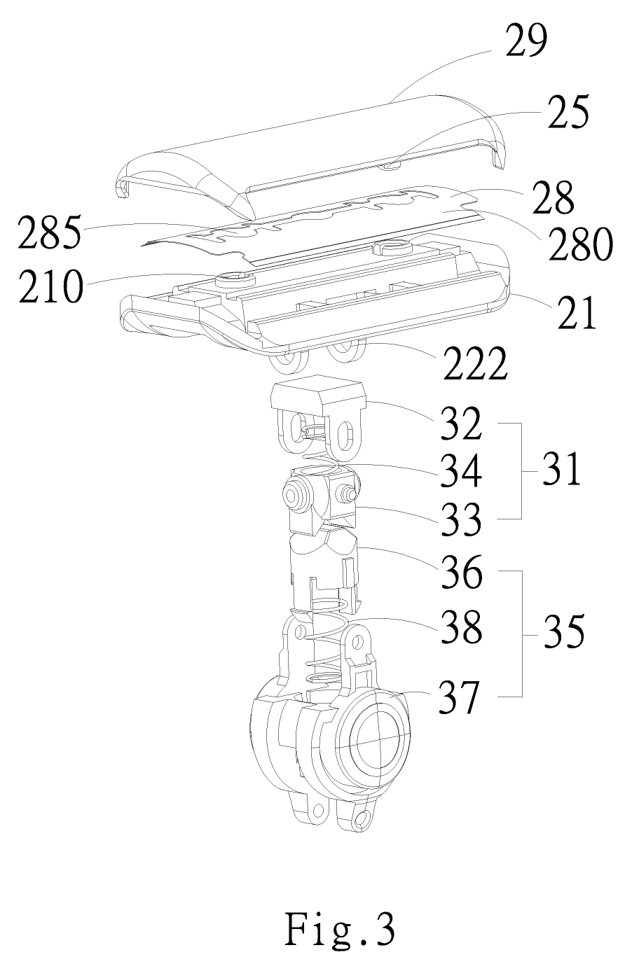

Please refer back to FIG. 2 and FIG. 3, the pair of rings 222 and the pair of buckle holes 3710 are both circular in shape, thus to allow the pair of positioning columns 337 and the pair of sliding columns 338 to rotate therein, respectively, i.e., when the first axial driving group 31 is driven, the shaving head 2 makes a rotating displacement in a front-rear direction with the pair of positioning columns 337 received in the pair of rings 222 as a pivot, and when the second axial driving group 35 is driven, the shaving head 2 makes a swing displacement in a left-right direction with the pair of sliding columns 338 received in the pair of buckle holes 3710 as a pivot.

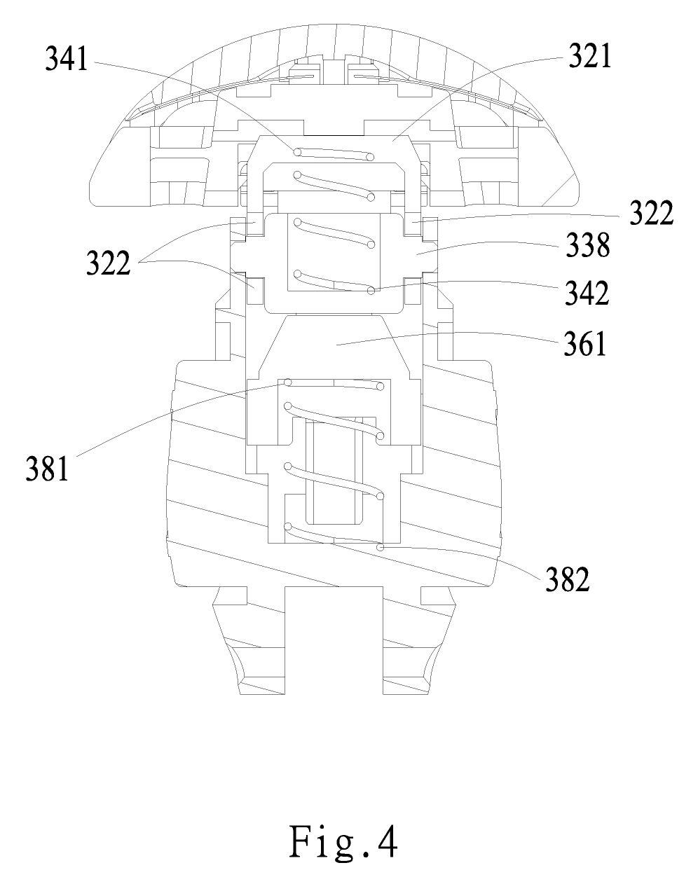

Please refer to FIGS. 5A and 5B as a cross-sectional view illustrating the first axial direction movement of the biaxial razor. When the shaving head 2 is driven to make a rotating displacement in a front-rear direction defined as the first axial direction (as shown by the arrow in FIG. 5A), the first pressing block 221 pushes the first pressed plate 321 downward to move the first adjustable shelf 32 to approach the static first stationary seat 33. In the meantime, the first spring 34 secured between the first adjustable shelf 32 and the first stationary seat 33 produces elastic energy storage for the shaving head 2 to return to its rest position(refer to FIG. 4).

Similarly, please refer to FIGS. 6A and 6B as a cross-sectional view illustrating the second axial direction movement of the biaxial razor. When the shaving head 2 is driven to make a swing displacement in a left-right direction defined as the second axial direction (as shown by the arrow in FIG. 6B), the second pressing block 330 pushes the second pressed plate 361 downward to move the second adjustable shelf 36 to approach the static second stationary seat 37. In the meantime, the second spring 38 secured between the second adjustable shelf 36 and the second stationary seat 37 produces elastic energy storage for the shaving head 2 to return to its rest position(refer to FIG. 6A).

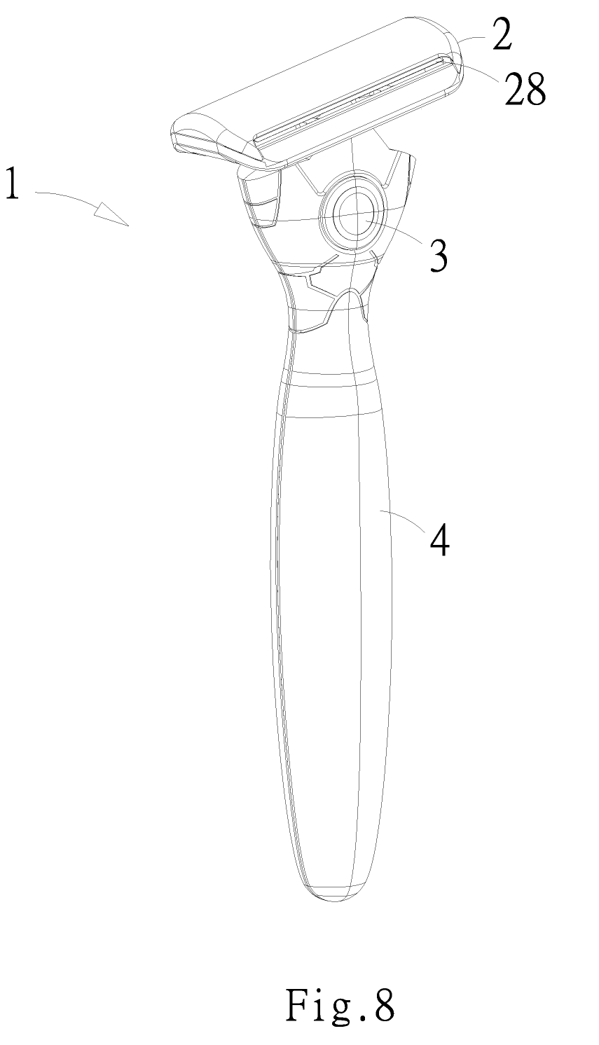

In sum, the biaxial razor 1 of the present invention utilizes the first and second axial driving groups 31,35 which are independent in structure and interact with each other in operations so as for moving the shaving head 2 toward multiple directions, such as front, rear, left, right, front left, front right, rear left, rear right, and so on (e.g. a movement of the shaving head 2 toward the front left direction as shown in FIG. 8), so as to perfectly fit with facial skins of users whose face contours are different, without taking lots of arm motions in operations when shaving, thereby to enhance the convenience in operations and improve the efficiency in shaving.

Besides, the biaxial razor 1 of the present invention is capable of adjusting tight intensities of the first and second springs 34,38 according to use requirements to control the operating sensitivities of the first and second axial driving groups 31,35 for achieving optimum comfort and general applicability.

And what is more is that the bilateral blade 28 of the shaving head 2 is exemplified as a single-blade type in the present invention, but not limiting to the single-blade type; a multiple-blade type is also included in the scope of the present invention.

It is understood that the invention may be embodied in other forms within the scope of the claims. Thus the present examples and embodiments are to be considered in all respects as illustrative, and not restrictive, of the invention defined by the claims.

What is claimed is:

1. A biaxial razor, including a shaving head, a handle, and a pivot assembly arranged between the shaving head and the handle, wherein:
the shaving head has a layer structure composed of a substrate, a bilateral blade and a cover board from bottom to top, the substrate is protruded downward to form a first pressing block, and left and right ends of the first pressing block further extend downward to form a pair of rings; and
the pivot assembly is composed of a first axial driving group and a second axial driving group, wherein:
the first axial driving group includes a first adjustable shelf, a first stationary seat and a first spring; the first adjustable shelf has a first pressed plate upwardly abutted on the first pressing block to make sure that when shaving, the first pressing block that is tilted pushes the first pressed plate downward; front and rear ends of the first pressed plate extend downward to form a pair of grooves; the first stationary seat is a hexahedron having a left surface, a right surface, a front surface, a rear surface, a top surface and a bottom surface, and disposed on the left and right surfaces of the first stationary seat is a pair of positioning columns that coincides with the pair of rings in size to provide the assembly and positioning of the substrate of the shaving head and the first stationary seat; disposed on the front and rear surfaces of the first stationary seat is a pair of sliding columns that is longitudinally movable within the pair of grooves; the first spring is secured between the first adjustable shelf and the first stationary seat;
the second axial driving group includes a second adjustable shelf, a second stationary seat and a second spring; the left and right surfaces of the first stationary seat extend downward to form a second pressing block corresponding to the second pressed plate; the second stationary seat has a base having a top surface, a bottom surface, a front surface, a rear surface, the front and rear surfaces of the base extend upward to form a pair of buckle holes that coincides with the pair of sliding columns in size to provide the assembly and positioning of the first and second stationary seats; the front and rear surfaces of the base are provided with a fixing element assembly for the combination with the handle; the top surface of the base of the second stationary seat is recessed to form a second sink that allows the second adjustable shelf to longitudinally slide therein; the second spring is secured between the second pressed plate and the second stationary seat;
wherein the pair of rings and the pair of buckle holes are both circular in shape, thus to allow the pair of positioning columns and the pair of sliding columns to rotate therein, respectively, i.e., when the first axial driving group is driven, the shaving head makes a rotating displacement in a front-rear direction with the pair of positioning columns received in the pair of rings as a pivot, and when the second axial driving group is driven, the shaving head makes a swing displacement in a left-right direction with the pair of sliding columns received in the pair of buckle holes as a pivot.

2. The biaxial razor of claim 1, wherein the substrate comprises a main board and a pair of sliding panels, the main board is substantively rectangular and has a long axis and a short axis that are perpendicular to each other, a pair of through holes is formed at left and right ends of the long axis of the main board and longitudinally penetrates the substrate, a pair of openings is formed on a surface of the bilateral blade corresponding to the pair of through holes, and the pair of sliding panels comprises a left sliding panel and a right sliding panel, the left sliding panel and the right sliding panel are actively assembled to left and right ends of a bottom surface of the main board, respectively, each of the left sliding panel and the right sliding panel is mounted with a first hook that extends toward the main board, the cover board is mounted with a second hook at left and right ends thereof, the second hook passes through each of the pair of openings and each of the pair of through holes to fasten with the first hook, thereby combining the substrate, the bilateral blade and the cover board together stably.

3. The biaxial razor of claim 2, wherein a first magnet is embedded in each of the left sliding panel and the right sliding panel while a second magnet magnetically attracted by the first magnet is embedded in the main board, wherein the first magnet is kept close to the first hook and the second magnet is kept close to the second hook, so that when the pair of sliding panels is moved laterally, the first hook of each of the left and right sliding panel is separated from the second hook of the cover board to dissemble the shaving head for the replacement of the bilateral blade, and when the cover board is assembled with the substrate, the first and second hooks rapidly fasten each other by magnetic attraction between the first and second magnets so as to realize quick combination.

4. The biaxial razor of claim 1, wherein the first pressed plate is designed to be flat so that when the first pressed plate is pushed downward, a tilted side of the first pressing block is capable of sliding on the first pressed plate unimpededly.

5. The biaxial razor of claim 1, wherein longitudinal widths of the pair of grooves are made larger than longitudinal widths of the pair of sliding columns.

6. The biaxial razor of claim 1, wherein the top surface of the first stationary seat is recessed to form a first sink to make the lower end of the first spring secured to bottom of the first sink, and an upper end of the second spring is secured to the second pressed plate of the second adjustable shelf, and a lower end of the second spring is secured to bottom of the second sink of the second stationary seat, so as to improve assembly stability of the first and second springs.

7. The biaxial razor of claim 1, wherein the second pressed plate has a first slant face at top, and the second pressing block has a second slant face at bottom that fits with the first slant face of the second pressed plate to strengthen the combination of the first stationary seat and the second adjustable shelf at rest, so that when shaving, the second pressing block that is tilted pushes the second pressed plate downward, and when the second pressed plate stops being pushed, the second pressing block returns to its rest position along the first and second slant faces rapidly.

8. The biaxial razor of claim 1, wherein edges of the second pressed plate extend downward to form a pair of third hooks, and a pair of slide chutes is longitudinally arranged on an inside wall of the second sink and allows the pair of third hooks to slide longitudinally therein, a pair of limiting members is mounted around upper ends of the pair of slide chutes to prevent the pair of third hooks from slipping out of the pair of slide chutes, so that the second adjustable shelf makes a longitudinal movement by sliding along the pair of slide chutes with the third hook, and the longitudinal movement range of the second adjustable shelf is limited by the pair of limiting members so as to prevent the second adjustable shelf to impact against the first stationary seat when the second adjustable shelf returns to its rest position, thereby to make sure the shaving head moves smoothly on user's face during shaving.

9. The biaxial razor of claim 1, wherein the fixing element assembly comprises a pair of fixing bones protruded from the front and rear surfaces of the base and a pair of fixing holes recessed on the base, and the handle is relatively mounted with a pair of fixing frames corresponding to the pair of fixing bones of the second stationary seat and a pair of fixing rods corresponding to the pair of fixing holes.

10. The biaxial razor of claim 1, wherein tight intensities of the first and second springs are adjusted in accordance with use requirements to control the operating sensitivities of the first and second axial driving groups for achieving optimum comfort and general applicability.
